(19) United States
(12) Patent Application Publication
(10) Pub. No.: US 2025/0214502 A1
(43) Pub. Date: Jul. 3, 2025

(54) E-TRACK BED SYSTEM

(71) Applicant: Jordan Wilking, Boerne, TX (US)

(72) Inventor: Jordan Wilking, Boerne, TX (US)

(21) Appl. No.: 18/402,912

(22) Filed: Jan. 3, 2024

(51) Int. Cl. B60P 3/39

(52) U.S. Cl. CPC B60P 3/39

(57) ABSTRACT

An e-track bed system is provided. The system includes a bed frame including e-track coupling devices rotatably coupled between a first side of the bed frame and an e-track mounting rail coupled to a wall of a trailer. The system further includes two first support legs rotatably coupled to the first side of the bed frame and may be locked in an extended position and a folded position. The system includes two second support legs rotatably coupled adjacent a second side of the bed frame. The second support legs rotate with respect to the bed frame based on gravity as the bed frame rotates. The first support legs are locked in the extended position and contact a floor surface to maintain the bed frame in the folded position. The first support legs are locked in the folded position to allow the bed frame to rotate to the unfolded position.

### BACKGROUND OF THE INVENTION

### Technical Field

This invention relates generally to folding bed system and more particularly to a folding bed system that couples to an e-track.

### State of the Art

The use of toy haulers and other trailers is common. Often times, trailers and toy haulers are utilized for much more than just hauling vehicles, equipment and the like. As owners remove the vehicles and equipment, they often utilize the trailer for sleeping and the like. In order to do so, trailers have become bigger and essentially operate as a recreational vehicle that can also be loaded with vehicles and equipment. These trailers and smaller trailers typically include e-tracks that operate to couple equipment to, to utilize to attach tie down to for holding the vehicles stationary during transport and the like. Whether a large toy hauler or smaller hauler or trailer, the ability to convert the trailer for sleeping or to add beds to an existing trailer are limited.

Accordingly, there is a need for a new e-track bed system that allows for a bed to be coupled to the e-track and fold away when not using it to sleep.

### SUMMARY OF THE INVENTION

An embodiment includes an e-track bed system comprising: a bed frame comprising e-track coupling devices rotatably coupled to a first side of the bed frame, wherein the e-track coupling device are coupled to an e-track mounting rail coupled to a wall of a trailer; two first support legs rotatably coupled to the first side of the bed frame with L-shaped brackets configured to releasably lock the first support legs in an extended position and a folded position; and two second support legs rotatably coupled adjacent a second side of the bed frame, wherein the second support legs rotate with respect to the bed frame based on gravity as the bed frame is rotated between the folded position and the unfolded position, wherein: the first support legs are locked in the extended position and contact a floor surface of the trailer maintain the bed frame in the folded position; and the first support legs are locked in the folded position substantially parallel with the bed frame allow the bed frame to rotate to the unfolded position.

Another embodiment includes a method of using e-track bed system comprising: rotatably coupling a bed frame to e-track mounting rail coupled to a wall, the bed frame rotatable between a folded position and an unfolded position; locking two first support legs rotatably coupled to the bed frame in an extended position to maintain the bed frame in the folded position; rotating and locking the two first support legs in the folded position; rotating the bed frame from the folded position to the unfolded position; automatically rotate second support legs coupled to the bed frame due to gravitational forces acting on the second support legs until the second support legs contact and rest on the floor surface as the bed frame rotates from the folded position to the unfolded position; and supporting the bed frame by the e-track mounting rail and the second support legs to maintain the bed frame in an orientation parallel to a floor surface.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of an e-track bed system in a folded position according to an embodiment;

FIG. 2 is a close-up perspective view of a support leg and bracket of an e-track bed system in a folded position according to an embodiment;

FIG. 3 is another close-up perspective view of a support leg and bracket of an e-track bed system in a folded position according to an embodiment;

FIG. 4 is an end view of an e-track bed system in an unfolded position according to an embodiment;

FIG. 5 is a close-up view of a support leg and bracket of an e-track bed system in an unfolded position according to an embodiment;

FIG. 6 is a perspective view of an e-track bed system in an unfolded position according to an embodiment; and

FIG. 7 is a perspective view of an e-track bed system with a mattress in an unfolded position according to an embodiment.

### DETAILED DESCRIPTION OF EMBODIMENTS OF THE INVENTION

As discussed above, embodiments of the present invention relate to a folding bed system that couples to an e-track.

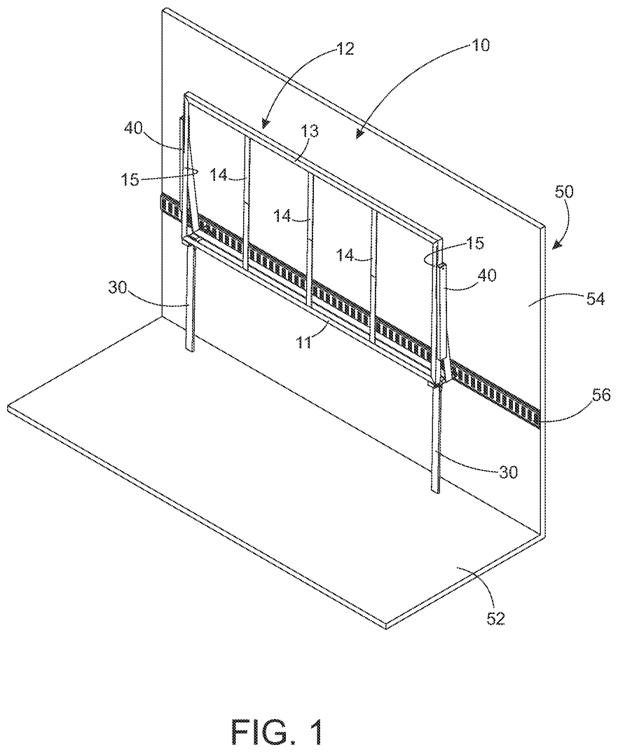

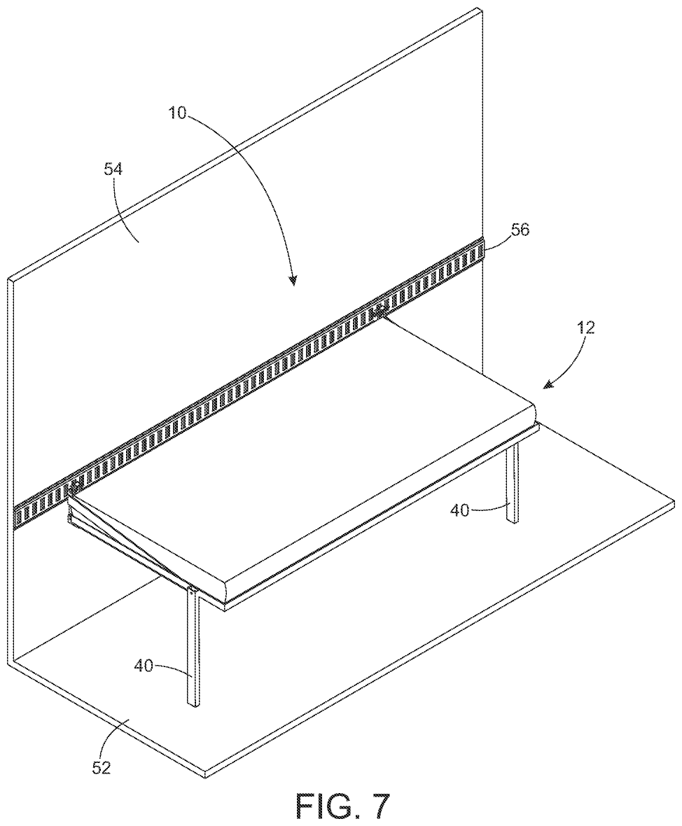

FIGS. 1-7 depict an e-track bed system 10 according to an embodiment. The system 10 comprises a bed frame 12 having a first side member 11, a second side member 13 and two end members 15 coupled between the first side member 11 and the second side member 13 at opposing ends of the first side member 11 and the second side member 13 to form a rectangular frame 12. Support members 14 are coupled between the first side member 11 and the second side member 13 and are substantially parallel to the two end members 15, wherein the support members 14 operate to strengthen the frame 12 and provide support for a mattress 100 to rest upon the support members 14 of the frame 12 (see FIG. 7).

The system 10 comprises two e-track members 16, each e-track member 16 is coupled on one end to the frame 12 at a corner of the frame 12 formed by the first side member 11 and one of the end members 15. The e-track members 16 extend toward a mattress side of the frame 12. Each e-track member 16 may be supported by support arm 13 that is coupled at an angle between the e-track member 16 and the end member 15 to form a triangular shape. E-track coupling devices 60 are coupled to ends of the e-track member 16 opposite to the end coupled to the frame 12. The e-track coupling devices 60 may be rotatably coupled to the e-track members 16 with a pins 62. The system 10 further comprises an e-track mounting rail 56 coupled to a wall 54, such as a wall of trailer 50. The e-track coupling devices 60 may be releasably coupled to the e-track mounting rail 56. These components operate to couple the frame 12 to the wall 54 and the frame 12 is thereby rotatable with respect to the wall 54.

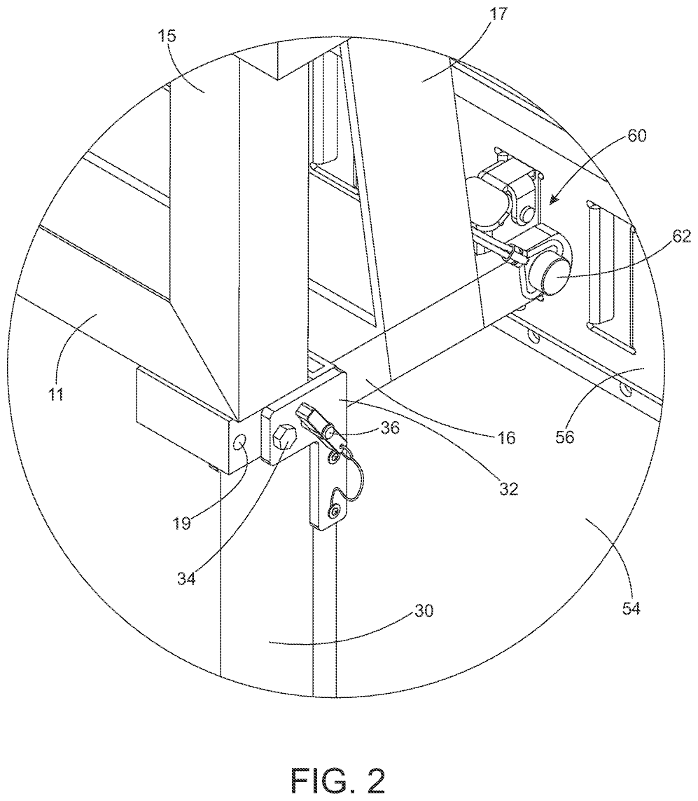

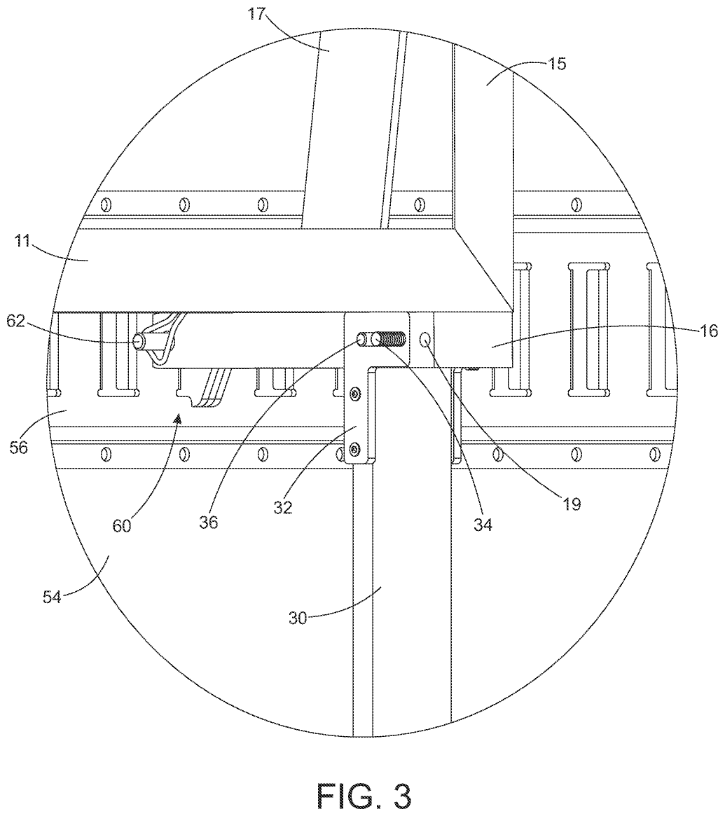

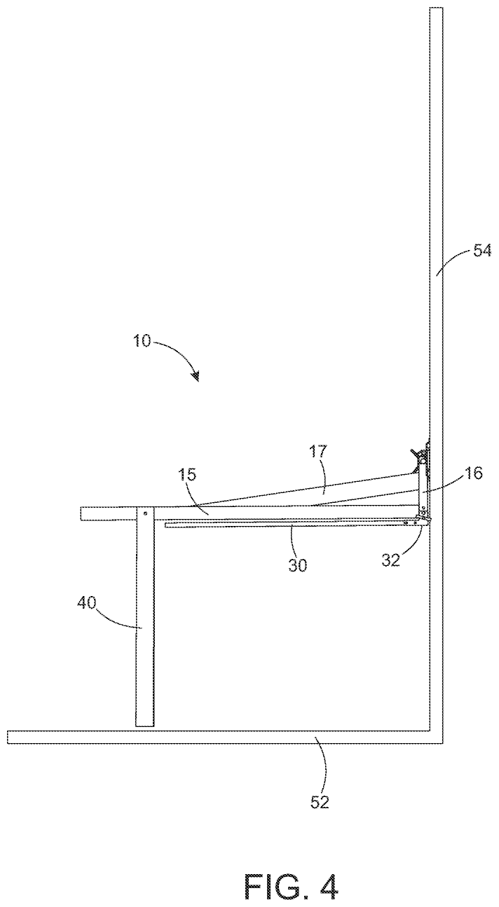

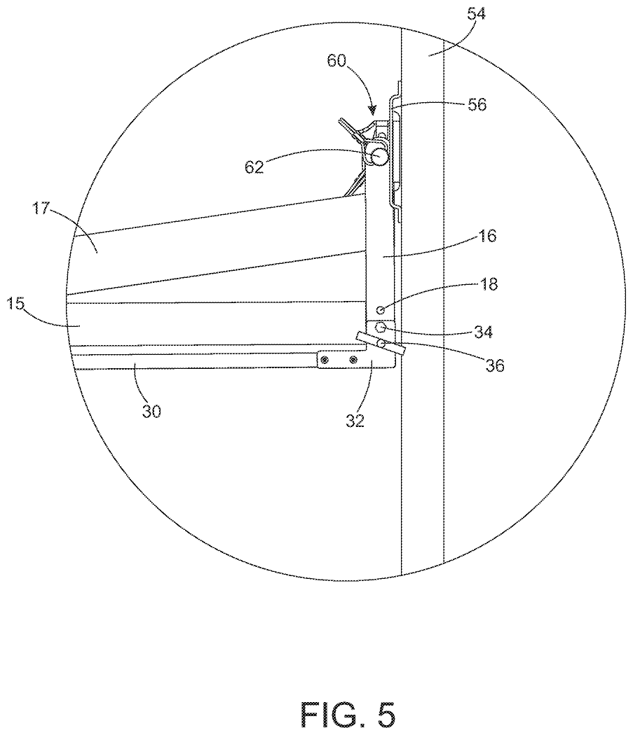

The system 10 further comprises first support legs 30, each first support leg 30 rotatably coupled to one e-track member 16 with an L-shaped bracket 32 with a coupler 34, such as a bolt. The e-track member 16 comprises a first aperture 18 and a second aperture 19. The coupler 34 couples the L-shaped bracket 32 to the e-track member 16 through an aperture between the first aperture 18 and the second aperture 19. In at least this way, the first support legs 30 are coupled to the first end 11 of the frame 12. The L-shaped bracket 32 is configured to releasably lock the first support legs 30 in an extended position and a folded position. To lock the first support leg 30 in the extended position, a lock pin 36 extends through a lock aperture 38 in the L-shaped bracket 32 and engages the first aperture 18 (see FIGS. 2-3). To lock the first support leg 30 in the folded position, the lock pin 36 extends through a lock aperture 38 in the L-shaped bracket 32 and engages the second aperture 19 (see FIGS. 4-5). The system 10 further comprises second support legs 40 rotatably coupled the end members 15 adjacent the second side member 13 of the bed frame 12.

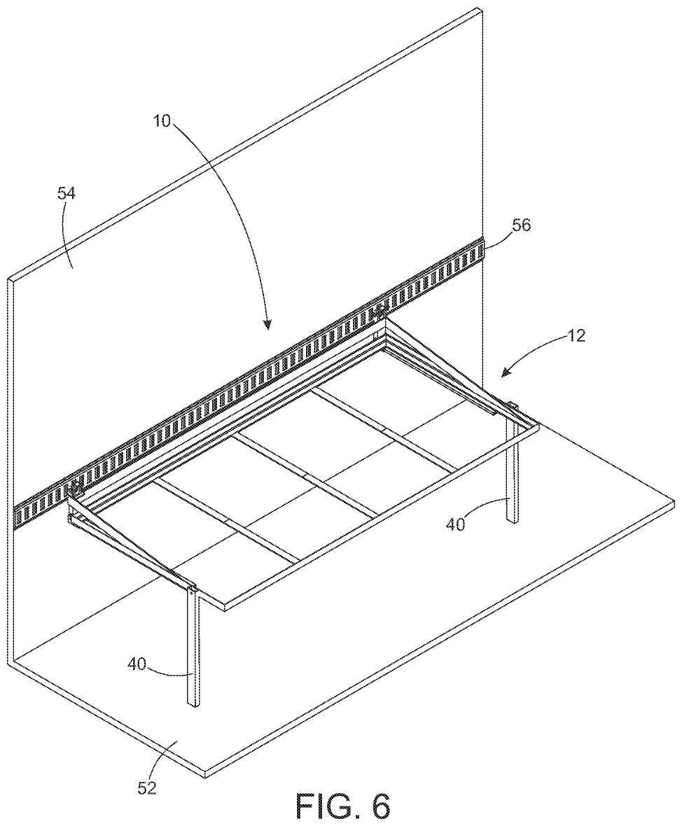

In operation, the second support legs 40 are rotated with respect to the bed frame 12 based on gravity as the bed frame 12 is rotated between the folded position and the unfolded position. When the first support legs 30 are locked in the extended position, the first support legs 30 contact a floor surface 52, such as a floor surface 52 of a trailer 50, to maintain the bed frame 12 in the folded position. When the first support legs 30 are locked in the folded position substantially parallel with the bed frame 12, it allows the bed frame 12 to rotate to the unfolded position. As the bed frame 12 rotates from the folded position to the unfolded position, the second support legs 40 automatically rotate due to gravitational forces acting on the second support legs 40 until the second support legs 40 contact and rest on the floor surface 52 (See FIG. 6). The bed frame 12 may then be supported by the e-track mounting rail 56 and the second support legs 40, as shown in FIG. 6. Referring additionally to FIG. 7, when a mattress 70 is coupled to the bed frame 12, the mattress is substantially parallel to the floor surface 52 and with the frame 12 in the unfolded position, the mattress 70 is in a condition to be laid on by a user.

Another embodiment includes a method of using e-track bed system comprising: rotatably coupling a bed frame to e-track mounting rail coupled to a wall, the bed frame rotatable between a folded position and an unfolded position; locking two first support legs rotatably coupled to the bed frame in an extended position to maintain the bed frame in the folded position; rotating and locking the two first support legs in the folded position; rotating the bed frame from the folded position to the unfolded position; automatically rotate second support legs coupled to the bed frame due to gravitational forces acting on the second support legs until the second support legs contact and rest on the floor surface as the bed frame rotates from the folded position to the unfolded position; and supporting the bed frame by the e-track mounting rail and the second support legs to maintain the bed frame in an orientation parallel to a floor surface.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An e-track bed system comprising:
a bed frame comprising e-track coupling devices rotatably coupled to a first side of the bed frame, wherein the e-track coupling device are coupled to an e-track mounting rail coupled to a wall of a trailer;
two first support legs rotatably coupled to the first side of the bed frame with L-shaped brackets configured to releasably lock the first support legs in an extended position and a folded position; and
two second support legs rotatably coupled adjacent a second side of the bed frame, wherein the second support legs rotate with respect to the bed frame based on gravity as the bed frame is rotated between the folded position and the unfolded position, wherein:
the first support legs are locked in the extended position and contact a floor surface of the trailer maintain the bed frame in the folded position; and
the first support legs are locked in the folded position substantially parallel with the bed frame allow the bed frame to rotate to the unfolded position.

2. The system of claim 1, further comprising two e-track members, each e-track member coupled on one end to the first side member of the bed frame at a corner of the bed frame formed by the first side member and one of the end members.

3. The system of claim 2, wherein the e-track members extend toward a mattress side of the bed frame.

4. The system of claim 3, wherein the e-track coupling devices are coupled to ends of the e-track members opposite to the ends coupled to the bed frame.

5. The system of claim 4, wherein the e-track coupling devices are rotatably coupled to the e-track members with pins.

6. The system of claim 2, wherein each first support leg is rotatably coupled to one e-track member with an L-shaped bracket by a coupler.

7. The system of claim 6, wherein each e-track member comprises a first aperture and a second aperture, wherein the coupler couples the L-shaped bracket to the e-track member through an aperture between the first aperture and the second aperture.

8. The system of claim 7, wherein the L-shaped bracket is configured to releasably lock the first support legs in an extended position and a folded position.

9. The system of claim 8, wherein to lock the first support leg in the extended position, a lock pin extends through a lock aperture in the L-shaped bracket and engages the first aperture.

10. The system of claim 9, wherein to lock the first support leg in the folded position, the lock pin extends through the lock aperture in the L-shaped bracket and engages the second aperture.

11. The system of claim 10, wherein the second support legs are rotated with respect to the bed frame by gravitational force as the bed frame is rotated between the folded position and the unfolded position.

12. The system of claim 11, wherein when the first support legs are locked in the extended position, the first support legs contact a floor surface of the trailer to maintain the bed frame in the folded position.

13. The system of claim 12, wherein when the first support legs are locked in the folded position substantially within the same plane with the bed frame, it allows the bed frame to rotate to the unfolded position.

14. The system of claim 13, wherein as the bed frame rotates from the folded position to the unfolded position, the second support legs automatically rotate due to gravitational forces acting on the second support legs until the second support legs contact and rest on the floor surface.

15. The system of claim 14, wherein the bed frame is supported by the e-track mounting rail and the second support legs.

16. The system of claim 15, further comprising a mattress coupled to the bed frame and held substantially parallel to the floor surface with the frame in the unfolded position.

17. A method of using e-track bed system comprising:
rotatably coupling a bed frame to e-track mounting rail coupled to a wall, the bed frame rotatable between a folded position and an unfolded position;
locking two first support legs rotatably coupled to the bed frame in an extended position to maintain the bed frame in the folded position;
rotating and locking the two first support legs in the folded position;
rotating the bed frame from the folded position to the unfolded position;
automatically rotate second support legs coupled to the bed frame due to gravitational forces acting on the second support legs until the second support legs contact and rest on the floor surface as the bed frame rotates from the folded position to the unfolded position; and
supporting the bed frame by the e-track mounting rail and the second support legs to maintain the bed frame in an orientation parallel to a floor surface.
